(19) United States
(12) Patent Application Publication
(10) Pub. No.: US 2026/0274152 A1
(43) Pub. Date: Sep. 17, 2026

(54) ARRANGEMENT STRUCTURE

(71) Applicant: KABUSHIKI KAISHA TOKAI-RIKA-DENKI-SEISAKUSHO, Niwa-gun, Aichi (JP)

(72) Inventors: Tomonori ICHIKAWA, Niwa-gun, Aichi (JP); Toshinari NAKAI, Niwa-gun, Aichi (JP)

(21) Appl. No.: 19/140,784

(22) PCT Filed: Nov. 17, 2023
(86) PCT No.: PCT/JP2023/041513

§ 371 Date: Jun. 18, 2025

(30) Foreign Application Priority Data
Dec. 23, 2022 (JP) 2022-207659

(51) Int. Cl. B60Q 1/00; B60Q 1/26; B60Q 1/56; B60R 1/26; B62J 45/41; F21S 43/20; F21W 103/50; F21W 107/17; F21Y 101/00

(52) U.S. Cl. CPC B60Q 1/0023; B60Q 1/0035; B60Q 1/0088; B60Q 1/2615; B60Q 1/56; B60R 1/26; B62J 45/41; F21S 43/26211; F21S 43/265; F21W 2103/50; F21W 2107/17; F21Y 2101/00

(57) ABSTRACT

In an arrangement structure, a camera mechanism is disposed above a lamp mechanism, the lamp mechanism emits light downward, and the camera mechanism captures an image rearward of the vehicle. Here, the imaging direction of the camera mechanism is oriented further upward than the light emission direction of the lamp mechanism. As a result, it is possible to suppress the influence of light from the lamp mechanism on image capture by the camera mechanism.

### TECHNICAL FIELD

The present invention relates to an arrangement structure in which an imaging mechanism is disposed on a vehicle such as a motorcycle.

### BACKGROUND ART

In the saddle riding-type vehicle described in Japanese Patent Application Laid-open (JP-A) No. 2001-151016, light means (front direction indicators, rear direction indicators, and tail lights) and imaging means (side rear imaging means and rear imaging means) are arranged in parallel.

In this saddle riding-type vehicle, the light emission direction of the light means and the imaging direction of the imaging means are not clear, and the light emission direction of the light means and the imaging direction of the imaging means are understood to be the horizontal direction.

In addition, in this kind of saddle riding-type vehicle, it is preferable that the position of the imaging target of the imaging means can be easily recognized.

### SUMMARY OF THE INVENTION

### Problem to be Solved by the Invention

In consideration of the above-mentioned circumstances, the present invention aims to obtain an arrangement structure that can suppress the influence of light from an illumination mechanism on imaging by an imaging mechanism, and an arrangement structure that can easily recognize the position of an imaging target of the imaging mechanism.

### Means for Solving the Problem

An arrangement structure of a first aspect of the present invention includes: an illumination mechanism that is installed in a vehicle that is a motorcycle, that is provided with a container having a shielding portion and a transmissive portion, and that is provided with an illumination unit inside the container, the illumination mechanism emitting light downward as a result of the illumination unit emitting light, the shielding portion shielding the light, and the transmissive portion transmitting the light; and an imaging mechanism that has at least one part disposed at a same position as the shielding portion in a vehicle front-rear direction, that images surroundings of the vehicle, and that has an imaging direction that is oriented further upward than a light emission direction of the illumination mechanism.

An arrangement structure of a second aspect of the present invention includes: an illumination mechanism that is installed in a vehicle that is a motorcycle, that is provided with a container having a shielding portion and a transmissive portion, and that is provided with an illumination unit inside the container, the illumination mechanism emitting light as a result of the illumination unit emitting light, the shielding portion shielding the light, and the transmissive portion transmitting the light; and an imaging mechanism that has at least one part disposed at a same position as the shielding portion in a vehicle front-rear direction, and that images surroundings of the vehicle and the vehicle.

An arrangement structure of a third aspect of the present invention is the arrangement structure of the first or second aspect of the present invention, in which the imaging mechanism is attached to the illumination mechanism.

An arrangement structure of a fourth aspect of the present invention is the arrangement structure of any one of the first to third aspects of the present invention, in which the imaging mechanism is attached to a vehicle body side.

An arrangement structure of a fifth aspect of the present invention is the arrangement structure of any one of the first to fourth aspects of the present invention, in which a wiring hole is provided at a vehicle body side, and wiring of the illumination mechanism and wiring of the imaging mechanism pass through the wiring hole.

An arrangement structure of a sixth aspect of the present invention is the arrangement structure of any one of the first to fifth aspects of the present invention, in which the imaging mechanism is disposed at a vehicle inner side relative to the illumination mechanism.

An arrangement structure of a seventh aspect of the present invention is the arrangement structure of any one of the first to sixth aspects of the present invention, in which a protruding part is provided around a lens of the imaging mechanism and protruding toward an imaging side of the imaging mechanism

### Effect of the Invention

In the arrangement structure of the first aspect of the present invention, an illumination mechanism is installed in a vehicle that is a motorcycle, and an illumination unit is provided inside a container of the illumination mechanism. Furthermore, as a result of the illumination unit emitting light, a shielding portion of the container blocks the light, and a transmissive portion of the container transmits the light, and the illumination mechanism emits the light downward. Further, at least a part of an imaging mechanism is disposed at the same position as the shielding portion in the vehicle front-rear direction, and the imaging mechanism captures an image of the surroundings of the vehicle.

Here, the imaging direction of the imaging mechanism is oriented further upward than the light emission direction of the illumination mechanism. As a result, it is possible to suppress the influence of light from the illumination mechanism on image capture by the imaging mechanism.

In the arrangement structure of the second aspect of the present invention, an illumination mechanism is installed in a vehicle that is a motorcycle, and an illumination unit is provided inside a container of the illumination mechanism. Furthermore, as a result of the illumination unit emitting light, a shielding portion of the container blocks the light, and a transmissive portion of the container transmits the light, and the illumination mechanism emits the light. Further, at least a part of an imaging mechanism is disposed at the same position as the shielding portion in the vehicle front-rear direction, and the imaging mechanism captures an image of the surroundings of the vehicle.

Here, the imaging mechanism captures an image of the vehicle. As a result, in the image captured by the imaging mechanism, the position of an imaging target in the vehicle surroundings relative to the vehicle can be recognized, and the position of the imaging target can be easily recognized.

In the arrangement structure of the third aspect of the present invention, the imaging mechanism is attached to the illumination mechanism. As a result, the imaging mechanism can be easily installed at the vehicle.

In the arrangement structure of the fourth aspect of the present invention, the imaging mechanism is attached to the side of the vehicle body. As a result, the mounting rigidity of the imaging mechanism can be increased.

In the arrangement structure of the fifth aspect of the present invention, the wiring of the illumination mechanism and the wiring of the imaging mechanism pass through a wiring hole at the side of the vehicle body. As a result, the configuration can be made simple.

In the arrangement structure of the sixth aspect of the present invention, the imaging mechanism is disposed at a vehicle inner side relative to the illumination mechanism, As a result, foreign matter reaching the imaging mechanism can be suppressed by the illumination mechanism.

In the arrangement structure of the seventh aspect of the present invention, a protruding part is provided around the lens of the imaging mechanism, and the protruding part protrudes toward the imaging side of the imaging mechanism. As a result, the incidence of unnecessary light at the lens can be suppressed.

### BRIEF DESCRIPTION OF DRAWINGS

FIG. 1 is a schematic side view of a vehicle according to a first embodiment of the present invention, as viewed from the right side.

FIG. 2 is an exploded perspective view showing an arrangement structure according to the first embodiment of the present invention, as viewed from the left and rear side of the vehicle.

FIG. 3A is a cross-sectional view showing the arrangement structure according to the first embodiment of the present invention, as viewed from the left side of a vehicle.

FIG. 3B is a cross-sectional view showing an arrangement structure according to a modified example of the first embodiment of the present invention, as viewed from the left side of the vehicle.

FIG. 4 is a schematic diagram showing an image captured by an imaging mechanism in the arrangement structure according to the first embodiment of the present invention.

FIG. 5A is a cross-sectional view showing the arrangement structure according to a second embodiment of the present invention, as viewed from the left side of a vehicle.

FIG. 5B is a cross-sectional view showing the arrangement structure according to a third embodiment of the present invention, as viewed from the left side of a vehicle.

### BEST MODE FOR CARRYING OUT THE INVENTION

### First Exemplary Embodiment

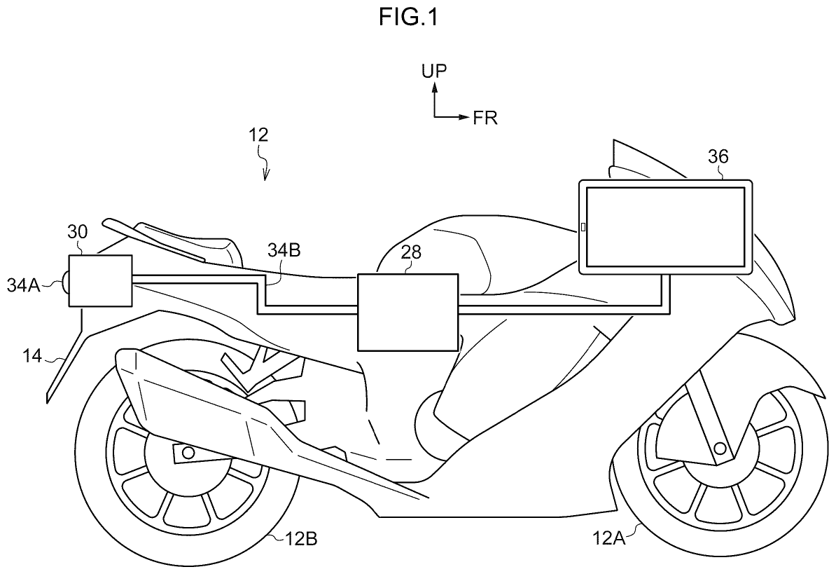

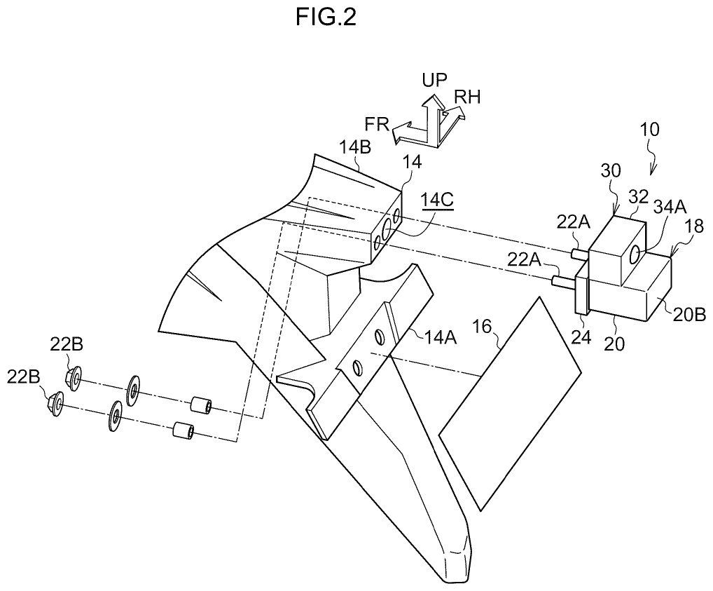

FIG. 1 shows a schematic side view of a vehicle 12 according to a first embodiment of the present invention, as viewed from the right side, and FIG. 2 shows an exploded perspective view of an arrangement structure 10 according to the present embodiment, as viewed from the left and rear side of the vehicle. Here, in the drawings, the forward direction of the vehicle is indicated by an arrow FR, the rightward direction of the vehicle is indicated by an arrow RH, and the upward direction is indicated by an arrow UP.

As shown in FIG. 1, the vehicle 12 in the present embodiment is a motorcycle, and a front wheel 12A and a rear wheel 12B are provided as vehicle wheels at the front and rear of the vehicle 12, respectively.

As shown in FIGS. 1 and 2, a rear fender 14 is provided at the rear of the vehicle 12 as a vehicle body side (covering member), and the rear fender 14 configures the body of the vehicle 12 and covers the rear side of the vehicle from above the rear wheel 12B. The rear fender 14 extends in the circumferential direction of the rear wheel 12B, and the rear fender 14 is curved in a convex shape at a side opposing the rear wheel 12B in the left-right direction of the vehicle.

A rectangular fixing plate 14A is integrally provided as a fixing portion at the vehicle rear side in a vertical direction middle portion of the rear fender 14, and the fixing plate 14A extends in the vehicle left and right directions, and extends to the vehicle left and right sides of the rear fender 14. The upper end of a rectangular license plate 16 (number plate) serving as an illumination target is fixed to the fixing plate 14A, and the front-side face of the license plate 16 faces rearward of the vehicle.

The rear fender 14 is integrally provided at its upper end with a substantially rectangular box-shaped mounting base 14B serving as an mounting portion, and the mounting base 14B protrudes rearward of the vehicle and has an interior that is open toward the front side of the vehicle. Further, a wiring hole 14C is formed through the vehicle rearward wall of the mounting base 14B at the center in the left-right direction of the vehicle.

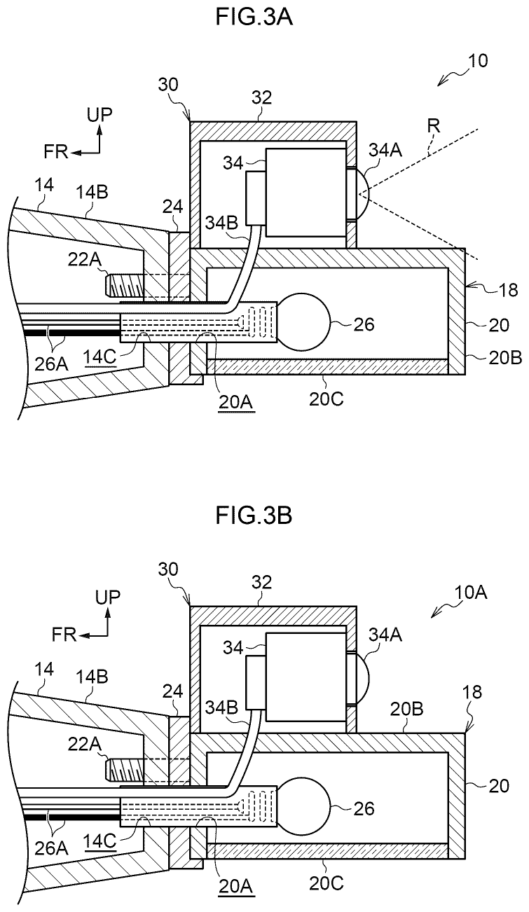

The arrangement structure 10 (see FIG. 3A) is mounted at the mounting base 14B of the rear fender 14.

The arrangement structure 10 is provided with a lamp mechanism 18, having a substantially rectangular parallelepiped shape, as an illumination mechanism, and a lamp housing 20, which has a substantially rectangular parallelepiped box-like shape and serves as a container, is provided at the outer periphery of the lamp mechanism 18. A bolt 22A is fixed to the vehicle left-side part and the vehicle right-side part of the vehicle front-side wall of the lamp housing 20, and the bolts 22A extend toward the front of the vehicle. The bolts 22A penetrate the vehicle rear-side wall of the mounting base 14B, and the lamp housing 20 is fastened to the mounting base 14B by screwing nuts 22B onto the bolts 22A, whereby the lamp mechanism 18 is mounted at the mounting base 14B. Further, a through hole 20A is formed through the vehicle front-side wall of the lamp housing 20 at the center in the vehicle left-right direction.

A rectangular plate-shaped sealing plate 24, as a sealing member, is provided at the vehicle front side of the lamp housing 20, and the sealing plate 24 is penetrated by the bolt 22A and has elasticity and sealing properties. The sealing plate 24 is held between the lamp housing 20 and the mounting base 14B and is elastically contracted, and the sealing plate 24 effects sealing between the lamp housing 20 and the mounting base 14B.

Portions of the lamp housing 20 other than the lower wall configure a shielding box 20B serving as a shielding portion, and the shielding box 20B has an inner surface that reflects light, and blocks light. The lower wall of the lamp housing 20 is a transmissive plate 20C configuring a transmissive portion, and the transmissive plate 20C is made transparent and is made light-transmissive. In the lamp housing 20 (in the shielding box 20B), a lamp 26 is fixed as an illumination unit, and the wiring 26A (power line) of the lamp 26 passes through the through hole 20A of the lamp housing 20, penetrates the sealing plate 24, passes through the wiring hole 14C in the rear fender 14 (mounting base 14B), and is connected to an illumination control device (not shown) of the vehicle 12. As a result, the lamp 26 is electrically connected to the illumination control device, and whenever a power supply of the vehicle 12 is turned on, the lamp 26 is supplied with power via the power line of the wiring 26A under the control of the illumination control device, and emits light. Furthermore, the light emitted by the lamp 26 is reflected by the inner surface of the shielding box 20B and passes through the transmissive plate 20C, as a result of which the lamp mechanism 18 emits light downward and illuminates the license plate 16. Further, the light emission direction of the lamp mechanism 18 (the direction of the central axis of the light emission range) is downward.

A substantially rectangular parallelepiped-shaped camera mechanism 30, configuring an imaging mechanism, is provided above the lamp mechanism 18, and a camera housing 20, which has a substantially rectangular parallelepiped box-like shape and configures an imaging container, is provided at the outer periphery of the camera mechanism 30. The bottom surface of the camera housing 32 is open, and the lower end of the camera housing 32 is fixed to the upper wall of the lamp housing 20 of the lamp mechanism 18 (the lamp housing 20 and the camera housing 32 may be integrally formed). The vehicle front-side wall of the camera housing 32 is aligned with the position of vehicle front-side wall of the lamp housing 20 in the vehicle front-rear direction, and the vehicle rear-side wall of the camera housing 32 is disposed further toward the vehicle front side than the vehicle rear-side wall of the lamp housing 20.

A substantially rectangular parallelepiped-shaped camera 34 is fixed in the camera housing 32 as an imaging device, and the camera 34 is disposed separately, upward, from the upper wall of the lamp housing 20 and has a vehicle rear-side face that contacts the vehicle rear-side wall of the camera housing 32. A lens 34A of the camera 34 protrudes from the vehicle rear-side face of the camera 34 toward the vehicle rear, and the lens 34A penetrates the vehicle rear-side wall of the camera housing 32 and is exposed at the vehicle rear side of the camera housing 32.

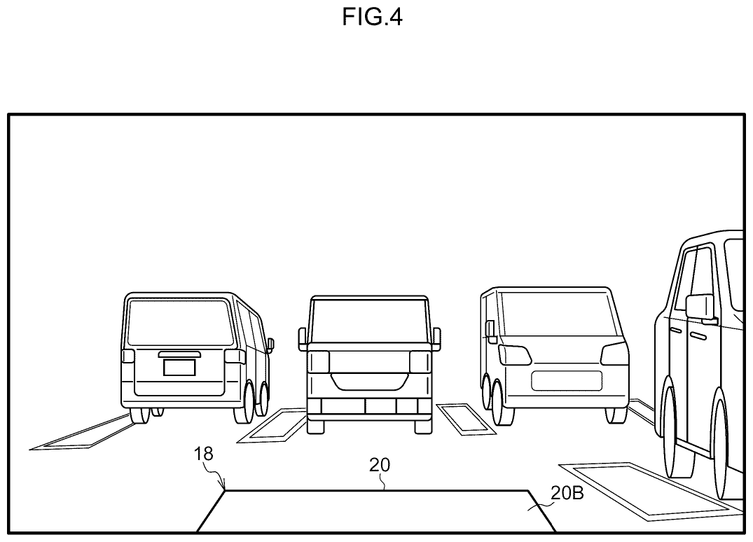

The wiring 34B (power line and footage line) of the camera 34 passes through the upper wall of the lamp housing 20 below the camera housing 32 and through the through hole 20A of the lamp housing 20, passes through the sealing plate 24, passes through the wiring hole 14C of the rear fender 14 (mounting base 14B), and is connected to a control device 28 of the vehicle 12. As a result, the camera 34 is electrically connected to the control device 28, and under the control of the control device 28, the camera 34 is supplied with electric power via the power line of the wiring 34B, and captures an image rearward of the vehicle (the side of the vehicle 12 at which the lamp mechanism 18 is disposed) via the lens 34A. The imaging direction of the camera 34 (the direction of the central axis of an imaging range R (the optical axis of the lens 34A)) is directed rearward of the vehicle, and the imaging range R of the camera 34 includes the vehicle rear-side end part of the camera housing 32. Further, the image captured by the camera 34 (see FIG. 4) is transmitted to the control device 28 via the footage line of the wiring 34B under the control of the control device 28.

The control device 28 is electrically connected to a display 36 that is a display device, and the display 36 is installed above a steering handle (not shown) of the vehicle 12. The screen of the display 36 is oriented toward the vehicle rear side, and an image captured by the camera 34 is displayed on the screen of the display 36 under the control of the control device 28. Therefore, the image displayed on the screen of the display 36, by being viewed by the rider of the vehicle 12, assists the rider's view rearward of the vehicle.

Next, the mechanism of the present embodiment is described.

In the arrangement structure 10 configured as above, the camera mechanism 30 is disposed above the lamp mechanism 18 (the shielding box 20B of the lamp housing 20), the lamp mechanism 18 emits light downward from the transmissive plate 20C of the lamp housing 20, and the camera mechanism 30 (camera 34) captures an image rearward of the vehicle via the lens 34A. Moreover, the image captured by the camera mechanism 30 is displayed at the screen of the display 36.

Here, the imaging direction of the camera mechanism 30 (rearward of the vehicle) is oriented further upward than the light emission direction of the lamp mechanism 18 (downward). As a result, it is possible to suppress intersection of the imaging range R of the camera mechanism 30 with the light emission range of the lamp mechanism 18, it is possible to suppress the influence of the light from the lamp mechanism 18 on the image capture by the camera mechanism 30, and it is possible to suppress a reduction in the quality of the image captured by the camera mechanism 30 due to light from the lamp mechanism 18.

Further, the camera mechanism 30 captures images not only rearward of the vehicle 12 but also of the lamp housing 20 of the vehicle 12. As a result, in the screen of the display 36 (the image captured by the camera mechanism 30), the rider can recognize the position (direction and distance) of an imaging target to the rear of the vehicle 12 relative to the lamp housing 20, and the position of the imaging target can be easily recognized.

Furthermore, the camera mechanism 30 captures an image of the vehicle rear-side end part of the lamp housing 20 of the vehicle 12 (the outer periphery of the vehicle 12). As a result, in the screen of the display 36, the rider can recognize the position (direction and distance) of an imaging target to the rear of the vehicle 12 relative to the vehicle rear-side end part of the lamp housing 20, and the position of the imaging target can be yet more easily recognized.

Further, the camera mechanism 30 (camera housing 32) is attached to the lamp mechanism 18 (lamp housing 20). As a result, by mounting the lamp mechanism 18 on the vehicle 12 (rear fender 14), the camera mechanism 30 can be mounted on the vehicle 12, and the camera mechanism 30 can be easily mounted on the vehicle 12.

Furthermore, the vehicle rear-side surface of the camera mechanism 30 is disposed at a vehicle front side (inner side of the vehicle 12) relative to the vehicle rear-side surface of the lamp mechanism 18. As a result, the lamp mechanism 18 (lamp housing 20) can inhibit foreign objects (water, soil, and the like) kicked up by the rear wheel 12B of the vehicle 12 from reaching the camera mechanism 30, and adhesion of foreign matter to the camera mechanism 30 (in particular, to the lens 34A) can be suppressed.

Furthermore, the camera mechanism 30 (camera housing 32) is attached to the rear fender 14 side of the lamp mechanism 18 (lamp housing 20). As a result, the attachment rigidity of the camera mechanism 30 can be increased, vibration of the camera mechanism 30 can be suppressed, and vibration of images captured by the camera mechanism 30 can be suppressed.

Further, the wiring 26A of the lamp mechanism 18 (lamp 26) and the wiring 34B of the camera mechanism 30 (camera 34) pass through the wiring hole 14C of the rear fender 14. As a result, there is no need to pass the wiring 26A of the lamp mechanism 18 and the wiring 34B of the camera mechanism 30 through separate holes in the rear fender 14, and the configuration of the rear fender 14 can be simplified.

Furthermore, the wiring 26A of the lamp mechanism 18 and the wiring 34B of the camera mechanism 30 pass through the through hole 20A of the lamp housing 20 and also pass through the same hole in the sealing plate 24. As a result, it is not necessary to pass the wiring 26A of the lamp mechanism 18 and the wiring 34B of the camera mechanism 30 through separate holes in the lamp housing 20 and the sealing plate 24, and the configuration of the lamp housing 20 and the sealing plate 24 can be simplified.

Furthermore, the wiring 34B of the camera mechanism 30 is routed through the camera housing 32 and the lamp housing 20 to the side of the rear fender 14. As a result, exposure of the wiring 34B of the camera mechanism 30 to the outside of the vehicle 12 can be limited, and the appearance of the vehicle 12 can be improved.

Further, the camera 34 of the camera mechanism 30 is disposed separately from the lamp mechanism 18 (lamp housing 20) at an upper side. As a result, it is possible to suppress transmission of heat from the lamp mechanism 18 (lamp 26) to the camera 34.

### Second Exemplary Embodiment

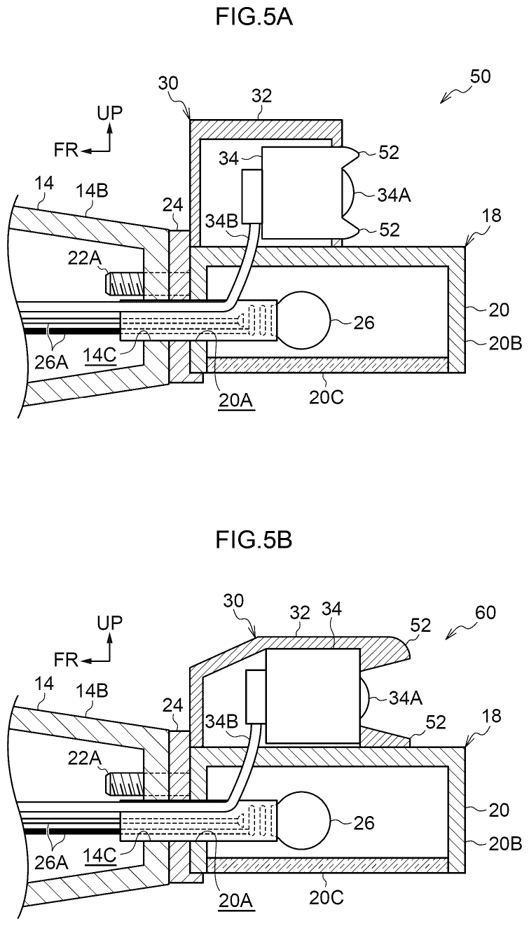

FIG. 5A shows a cross-sectional view of an arrangement structure 50 according to a second embodiment of the present invention, as viewed from the vehicle left side.

The arrangement structure 50 according to the present embodiment has a configuration substantially similar to that of the first embodiment, but differs in the following respects.

As shown in FIG. 5A, in the arrangement structure 50 according to the present embodiment, in the camera mechanism 30, the camera 34 penetrates the vehicle rear-side wall of the camera housing 32, and the vehicle rear-side surface of the camera 34 is exposed from the vehicle rear-side wall of the camera housing 32. A cylindrical protrusion 52 is integrally provided as a protruding part at the entire outer periphery of the lens 34A at the vehicle rear-side face of the camera 34, and the protrusion 52 protrudes rearward of the vehicle and has a triangular cross section. A surface of the projection 52 at the side of the lens 34A is inclined in the direction of an opposite side from the lens 34A on progression toward the rear of the vehicle, and the protrusion 52 is disposed outside the imaging range R of the camera 34.

Here, in the present embodiment, too, the same mechanism and effects can be achieved as in the first embodiment.

Furthermore, the protrusion 52 around the lens 34A of the camera mechanism 30 protrudes rearward of the vehicle (the image capture side of the camera mechanism 30). As a result, it is possible to suppress the incidence of unnecessary light (such as sunlight) on the lens 34A, and also to suppress the adhesion of foreign matter (water, soil, and the like) to the lens 34A, and it is possible to suppress a reduction in the quality of the image captured by the camera mechanism 30.

Furthermore, the protrusion 52 is disposed outside the imaging range R of the camera mechanism 30 (camera 34). As a result, it is possible to suppress interference by the protrusion 52 with image capture by the camera mechanism 30.

### Third Exemplary Embodiment

FIG. 5B shows a cross-sectional view of an arrangement structure 60 according to a third embodiment of the present invention, as viewed from the vehicle left side.

The arrangement structure 60 according to the present embodiment has a configuration substantially similar to that of the first embodiment, but differs in the following respects.

As shown in FIG. 5B, in the arrangement structure 60 according to the present embodiment, in the camera mechanism 30, a protrusion 52 similar to that of the second embodiment is integrally provided at the vehicle rear-side wall of the camera housing 32 around the entire outer periphery of the lens 34A, and the protrusion 52 has a substantially trapezoidal cross section.

Here, in the present embodiment, too, the same mechanism and effects can be achieved as in the second embodiment.

In the first to third embodiments described above, the wiring 34B of the camera mechanism 30 is routed through the interior of the lamp housing 20, the sealing plate 24 and the rear fender 14. However, for example, as in the arrangement structure 10A according to a modified example of the above-described first embodiment shown in FIG. 3B, the wiring 34B of the camera mechanism 30 may be routed through a peripheral wall of the camera housing 32 (such as the vehicle front-side wall) and the rear fender 14 (for example, the upper wall of the mounting base 14B).

Further, in the first to third embodiments described above, the camera mechanism 30 is attached to the lamp mechanism 18. However, the camera mechanism 30 may be attached to the rear fender 14 (at the side of the vehicle body), and for example, the vehicle front-side wall of the camera housing 32 may be extended downward and attached to the mounting base 14B of the rear fender 14 together with the lamp mechanism 18 by fastening with the bolts 22A and nuts 22B. As a result of this, the mounting rigidity of the camera mechanism 30 can be effectively increased, vibration of the camera mechanism 30 can be effectively suppressed, and vibrations in the image captured by the camera mechanism 30 can be effectively suppressed.

Furthermore, in the first to third embodiments described above, the camera mechanism 30 is attached to the upper side of the lamp mechanism 18 (lamp housing 20). However, it is sufficient that at least a portion of the camera mechanism 30 is disposed at the same position as the lamp mechanism 18 (lamp housing 20) in the vehicle front-rear direction, and further, the camera mechanism 30 need not be attached to the lamp mechanism 18 (lamp housing 20).

Further, in the first to third embodiments described above, the camera mechanism 30 is provided with a camera housing 32. However, in the first and second embodiments described above, the camera mechanism 30 need not be provided with the camera housing 32. In such a case, the camera 34 is attached, for example, to the lamp housing 20 by an attachment member such as a bracket or double-sided tape.

Furthermore, in the first to third embodiments described above, at least a portion of the power line for the wiring 26A of lamp 26 and the power line for the wiring 34B of camera 34 may be shared. As a result of this, the configuration of the wiring 26A of the lamp 26 and the wiring 34B of the camera 34 can be simplified.

Further, in the first to third embodiments described above, the lower wall of the lamp housing 20 is the transmissive plate 20C. However, for example, the lower wall and the vehicle rear-side wall of the lamp housing 20 may be formed as transmissive plates 20C.

Furthermore, in the first to third embodiments described above, the camera mechanism 30 (camera 34) captures visible light. However, the camera mechanism 30 (camera 34) may capture light such as infrared light.

Further, in the first to third embodiments described above, the motorcycle that is the vehicle 12 is provided with two vehicle wheels (a front wheel 12A and a rear wheel 12B). However, the motorcycle that is the vehicle 12 may be provided with three or more vehicle wheels.

The disclosure of Japanese Patent Application No. 2022-207659 filed on Dec. 23, 2022, is incorporated by reference herein in its entirety.

### Explanation of the Reference Symbols

10: arrangement structure, 10A: arrangement structure, 12: vehicle, 14: rear fender (vehicle body side), 14C: wiring hole, 18: lamp mechanism (illumination mechanism), 20: lamp housing (container), 20B: shielding box (shielding portion), 20C: transmissive plate (transmissive portion), 26: lamp (illumination unit), 26A: wiring, 30; camera mechanism (imaging mechanism), 34A: lens, 34B: wiring, 50: arrangement structure, 52: protrusion (protruding part), 60: arrangement structure

1. An arrangement structure, comprising:
an illumination mechanism that is installed in a vehicle that is a motorcycle, that is provided with a container having a shielding portion and a transmissive portion, and that is provided with an illumination unit inside the container, the illumination mechanism emitting light downward as a result of the illumination unit emitting light, the shielding portion shielding the light, and the transmissive portion transmitting the light; and
an imaging mechanism that has at least one part disposed at a same position as the shielding portion in a vehicle front-rear direction, that images surroundings of the vehicle, and that has an imaging direction that is oriented further upward than a light emission direction of the illumination mechanism.

2. An arrangement structure, comprising:
an illumination mechanism that is installed in a vehicle that is a motorcycle, that is provided with a container having a shielding portion and a transmissive portion, and that is provided with an illumination unit inside the container, the illumination mechanism emitting light as a result of the illumination unit emitting light, the shielding portion shielding the light, and the transmissive portion transmitting the light; and
an imaging mechanism that has at least one part disposed at a same position as the shielding portion in a vehicle front-rear direction, and that images surroundings of the vehicle and the vehicle.

3. The arrangement structure of claim 1, wherein the imaging mechanism is attached to the illumination mechanism.

4. The arrangement structure of claim 1, wherein the imaging mechanism is attached to a vehicle body side.

5. The arrangement structure of claim 1, wherein a wiring hole is provided at a vehicle body side, and wiring of the illumination mechanism and wiring of the imaging mechanism pass through the wiring hole.

6. The arrangement structure of claim 1, wherein the imaging mechanism is disposed at a vehicle inner side relative to the illumination mechanism.

7. The arrangement structure of claim 1, wherein a protruding part is provided around a lens of the imaging mechanism and protruding toward an imaging side of the imaging mechanism.

8. The arrangement structure of claim 1, wherein a camera of the imaging mechanism is disposed separately from the illumination mechanism.

9. The arrangement structure of claim 1, wherein wiring of the imaging mechanism is routed to a vehicle body side via an interior of the illumination mechanism.

10. The arrangement structure of claim 1, wherein a camera is accommodated inside an imaging container in the imaging mechanism.

11. The arrangement structure of claim 2, wherein the imaging mechanism is attached to the illumination mechanism.

12. The arrangement structure of claim 2, wherein the imaging mechanism is attached to a vehicle body side.

13. The arrangement structure of claim 2, wherein a wiring hole is provided at a vehicle body side, and wiring of the illumination mechanism and wiring of the imaging mechanism pass through the wiring hole.

14. The arrangement structure of claim 2, wherein the imaging mechanism is disposed at a vehicle inner side relative to the illumination mechanism.

15. The arrangement structure of claim 2, wherein a protruding part is provided around a lens of the imaging mechanism and protruding toward an imaging side of the imaging mechanism.

16. The arrangement structure of claim 2, wherein a camera of the imaging mechanism is disposed separately from the illumination mechanism.

17. The arrangement structure of claim 2, wherein wiring of the imaging mechanism is routed to a vehicle body side via an interior of the illumination mechanism.

18. The arrangement structure of claim 2, wherein a camera is accommodated inside an imaging container in the imaging mechanism.
